(19) United States
(12) Patent Application Publication
(10) Pub. No.: US 2004/0120140 A1
(43) Pub. Date: Jun. 24, 2004

(54) Illuminated graphics using fluorescing materials

(76) Inventors: Michael E. Fye, Kokomo, IN (US); Paul A. Uglum, Noblesville, IN (US); Raymond Lippmann, Howell, MI (US); Gail M. Sylvesper, Frankenmuth, MI (US)

Correspondence Address: STEFAN V. CHMIELEWSKI, DELPHI TECHNOLOGIES, INC., Legal Staff Mail Code: CT10C, P.O. Box 9005, Kokomo, IN, 46904-9005, US

(21) Appl. No.: 10/732,987

(22) Filed: Dec. 11, 2003

Related U.S. Application Data
(63) Continuation-in-part of application No. 10/107,766, filed on Mar. 27, 2002.

(51) Int. Cl. F21V 9/16

(52) U.S. Cl. 362/84

(57) ABSTRACT

A backlit display is disclosed. The backlit display comprises at least one light source, a backlit component, and a light-passing substrate. The light-passing substrate includes at least one fluorescing material. The light-passing substrate is intermediately located between the light source and the backlit component such that the backlit component passes light through at least one selected portion of said substrate. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### TECHNICAL FIELD

The present invention relates to the field of illuminated displays. More specifically, the invention relates to generating color graphics within an illuminated display.

### BACKGROUND OF THE INVENTION

Various types of lights can be used as the light source in illuminated displays, such as a backlit display, with the choice often dictated by the industry and the application in which the back light is going to be utilized. For instance, in the automotive industry, light emitting diodes (LEDs) are commonly-used in backlit displays due to their size, durability, longevity and energy consumption properties. However, due to their nature, it is difficult to manufacture LEDs that emit light over a large range of wavelengths, which in turn makes their use in backlit displays difficult. For instance, commonly used blue LEDs do not emit light of the appropriate wavelengths required to properly illuminate the colors yellow, orange or red in a backlit display. Multi-wavelength LEDs do exist, but commonly-available white LEDs tend to be expensive and have varying colors and wavelengths in their emitted light.

Prior art structures 1 used to control backlighting of graphics often rely on coating a light cover with multiple layers of light-modifying materials to generate the desired visual effect of the graphics. For example, as shown in FIG. 1, a cover 9 made of a substrate 3 and a diffusing layer 4 to diffuse the emitted light may cover a light source 2. A fluorescing layer 5 and a graphics color layer 6 are deposited on top of the diffusing layer 4 to absorb light energy that does not correspond to the desired color. An opaque topcoat 7 with an opening 8 in the shape of the desired graphic allows the light escaping the cover 9 to reach the viewer. This complicated layered structure, however, requires many manufacturing steps, introducing a high degree of variability between components.

There is a desire for a simplified apparatus and method that can control colors in an illuminated display.

### SUMMARY OF THE INVENTION

Accordingly, one embodiment of the invention is directed to a backlit display, comprising at least one light source, a backlit component, and a light-passing substrate. The light-transmitting substrate includes at least one fluorescing material. The light-transmitting substrate is intermediately located between the light source and the backlit component such that the backlit component converts light within at least one selected portion of said substrate.

### BRIEF DESCRIPTION OF THE DRAWINGS

The present invention will now be described, by way of example, with reference to the accompanying drawings, in which:

FIG. 1 is a representative diagram of a known apparatus for illuminating displays;

FIG. 2 is a representative diagram of one embodiment of the inventive apparatus;

FIG. 3 is a CIE chromaticity diagram illustrating output color data points corresponding to appropriately colored plastic with dye or dyes stimulated by a reference color of a light source;

FIG. 4 is a representative diagram of another embodiment of the inventive apparatus;

FIG. 5 is a representative diagram of another embodiment of the inventive apparatus;

FIG. 6 is a representative diagram of another embodiment of the inventive apparatus;

FIG. 7A is a representative diagram of another embodiment of the inventive apparatus;

FIG. 7B is a representative diagram of another embodiment of the inventive apparatus;

FIG. 8 is a top view of another embodiment of the inventive apparatus;

FIG. 9 is a side cross-sectional view of another embodiment of the inventive apparatus;

FIG. 10 is a front cross-sectional view of another embodiment of the inventive apparatus; and

FIGS. 11A and 11B are spectral diagrams illustrating the effect of one embodiment of the invention on transmitted light.

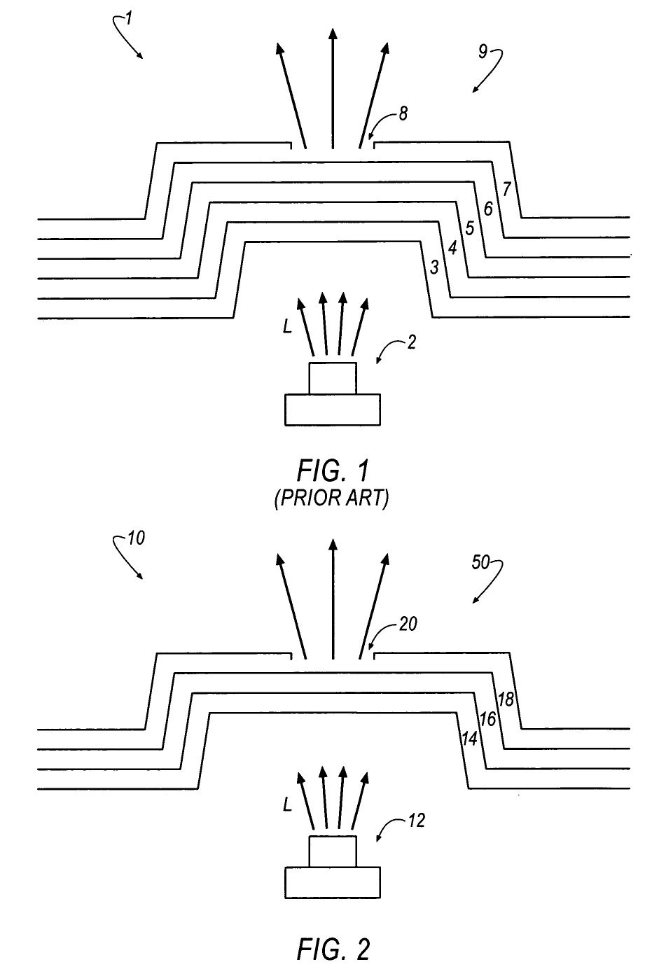

### DESCRIPTION OF THE EMBODIMENTS

FIG. 2 illustrates one embodiment of an inventive system for illuminating displays, such as a backlit display 10. In this example, a back light source 12 emits light, L, toward substrate 14, which forms the base of a cover 50. In one embodiment, the substrate 14 is made of a transparent or translucent plastic resin, such as a natural polycarbonate or acrylic, that can be formed into a variety of shapes and sizes. Regardless of the specific material used in the substrate 14, the substrate 14 itself should allow at least some light, L, to pass through it. The substrate 14 may be formulated to incorporate into its compositional makeup both a diffusing substance and one or more fluorescing materials, such as dyes or pigments.

The light, L, emitted from the light source 12 is herein after referred to as a ‘reference color.’ According to one embodiment of the invention, the reference color is blue and emits from a blue-colored light emitting diode (LED 12). The LED 12 emits a spectrum of light energy with a dominant wavelength of approximately 464 nanometers. This blue light excites the compositional makeup of the substrate 14, which absorbs light, L, comprising shorter wavelengths and re-emits the light, L, comprising longer wavelengths. This process is known as “down-converting.” The resultant light spectrum produced by this process can be tuned by various fluorescent dye concentrations to a multiplicity of desired colors. The resulting color gamut is defined by the blue LED 12 and available commercial dyes included in the substrate 14.

According to one embodiment, the diffusing substance included in the substrate 14 is silica-based. In an alternative embodiment, it is acrylic-based, a Polytetrafluoroethylene (PTFE) material, or an inorganic filler. Regardless of these embodiments, the diffusing substance is not limited to these examples, but can be any appropriate composition that can introduce light scattering particles into the makeup of the substrate 14. As explained above, one or more fluorescing materials may also incorporated into the substrate 14. One possible dye for the substrate 14 may be selected from the BASF Lumogen (R or F) Series that allows for easy integration into the substrate 14, although other forms and types of dyes could be used. The appropriate dye or dyes are selected based on the type of light source 12 used and the desired color or colors one wishes to depict in a graphic.

For instance, after determining the color of the graphic one wishes to depict, one or more dyes are selected such that the spectra of light emitted by the dye falls on both sides of the specific frequency of light associated with the color of the graphic. For a practical example, if a green-colored arrow is to be displayed on a button in an instrument panel, the substrate 14 of the cover 50 could be formed into the shape of the button and contain yellow-colored fluorescing dye. Because the reference color is blue, converting light, L, from the blue LED 12 within the yellow substrate 14 generates a green illuminated graphic. In another example, the substrate 14 may include an orange-colored fluorescing dye to generate a pink illuminated graphic.

Essentially, the substrate 14 may include any desirable (optically clear) material, such as a polycarbonate or acrylic-based binder that contains a diffusing acrylic, silica, polytetrafluoroethylene or glass additive and/or any desirable dye. The scattering particles may be comprised of a very fine, powder of particles or microspheres, which may be solid or hollow, to scatter the light within the substrate 14 to assist in the spreading and converting the color of the light, L. The diffusant effectively increases the path that blue photons travel through the material thickness, making the color conversion more efficient. The diffusant increases the likelihood of an interaction of a blue photon with a dye molecule. Other embodiments of the substrate 14, if desired, may only include the diffuser without a dye; in this instance, the substrate 14 would simply be a diffuser and reorients the emitted light, L, from the light source 12. Likewise, the substrate 14 may contain only a dye (or mixture of dyes) without a diffuser. Because the blue photons will pass through this material with less dye interaction, more dye or thicker material is required to produce a color equivalent to that with a diffusant.

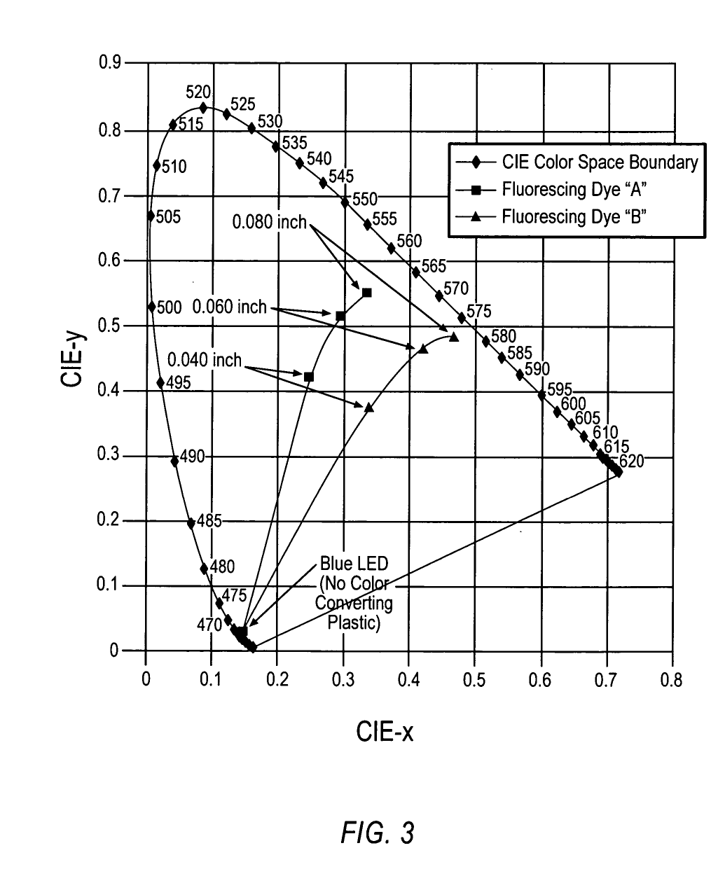

As shown in FIG. 3, a Commission Internationale de l'Eclairage (CIE) chromaticity diagram illustrates appropriately colored dye or dyes that may be selected based on the type of reference color of the light source 12 and the desired output color for the back-lit display button, graphic, or indicia. More specifically, the CIE diagram defines all colors on a 2 dimensional x,y plot and illustrates an example of how colors may be attained by incorporating the blue LED 12 and two particular dyes, which are generally shown at “Fluorescing Dye A” and “Fluorescing Dye B.” The CIE diagram depicts the multidimensional subjective relationship among colors perceived by the normal human visual system (i.e. eyes and nervous system, including the brain) when additively stimulated by two or more, usually three discrete monochromatic visible sources (i.e. wavelengths).

When “Fluorescing Dye A” is used in varying thicknesses of plastic for the substrate 14 (e.g. 0.040″, 0.060″, and 0.080″ thicknesses) with blue LED 12, achievable colors are represented on the line from the blue LED through the data points shown. In the first example thickness at 0.040″, the resultant color of the first data point is a bluish green. Additional material thickness drives the resultant color into the green region of the CIE chromaticity diagram. In another example, when “Fluorescing Dye B” is used in a likewise manner, the first data point at 0.040″ is nearly white, and additional material thickness drives the color into the yellow-green area of the CIE chromaticity diagram. In another possible example, by mixing Fluorescing Dyes “A” and “B,” colors that fall between these lines may be achieved. It is also possible to further tune the resultant color by changing the concentration of dye in the substrate 14.

A reduction in dye concentration for either dye “A” or “B” will direct the generated color closer to that of the blue LED 12, whereas increasing the dye concentration will direct the color farther away from the blue LED color. Although a blue LED is used for the light source 12 in both examples discussed above, any colored light source 12 may used in place of the blue LED as long as the resulting converted light has longer wavelengths than the stimulating light source.

As stated above, a blue-colored LED is a desirable choice for the light source 12 because blue is among the shorter wavelengths of the visible spectrum. Other types of shorter-wavelength LED colors, such as green, purple, or ultra-violet, may be used as well; however, if an ultra-violet light source is used, the backlit display 10 may further comprise a filter used to remove ultra-violet light unconverted by the substrate 14 to a longer wavelength color. Although only one LED 12 is illustrated, more than one LED 12 may be included in the invention. If more than one LED is included, the LEDs may comprise different colors, or alternatively, the same color.

According to one embodiment, the substrate 14 is manufactured by standard coloring and extrusion techniques within the polymer industry. In one example provided for illustrative purposes, pellets of natural polycarbonate or acrylic resin are introduced into a tumbler, along with a silica-based powder comprising the diffusing substance and one or more powdered dyes. The subsequent mixture is then fed into a hopper and fed into the heated screw of an extruder to melt the resin and combine the mixture uniformly. The mixture is then cooled and chopped into uniformly-colored pellets. The final substrate can then be reformed through standard injection molding techniques.

Referring back to FIG. 2, an optional coating layer 16 may be disposed on the substrate 14. The coating layer 16 may be colored to provide a desired daytime graphics appearance and to hide the substrate 14 underneath it. An opaque topcoat 18 is then applied onto the coating layer 16 to block light from passing through areas other than through the opening 20 formed in the cover 50. One or more openings 20 are selectively cut into the topcoat 18 to reveal portions of the coating layer 16 underneath. The opening 20 can have any shape of any desired graphic, such as an arrow, words, numbers, etc. so the user ultimately sees an illuminated graphic having the color of the exposed coating layer 16. Note that if the coating layer 16 is omitted from the cover 50, the opaque layer 18 may be deposited directly onto the substrate 14.

In one embodiment, the openings 20 in the opaque topcoat 18 are formed via a laser-etching process. Essentially, a laser heats the opaque material to the point of evaporation, thereby allowing precise cuts to be made in the opaque topcoat 18. In an alternative embodiment, an etching process, a printing process, or two-shot molding injection molding process could be used. The invention is not limited to these methods, but could use any appropriate means for selectively removing portions of the opaque topcoat 18 to form one or more openings 20 in the shape of the desired graphic.

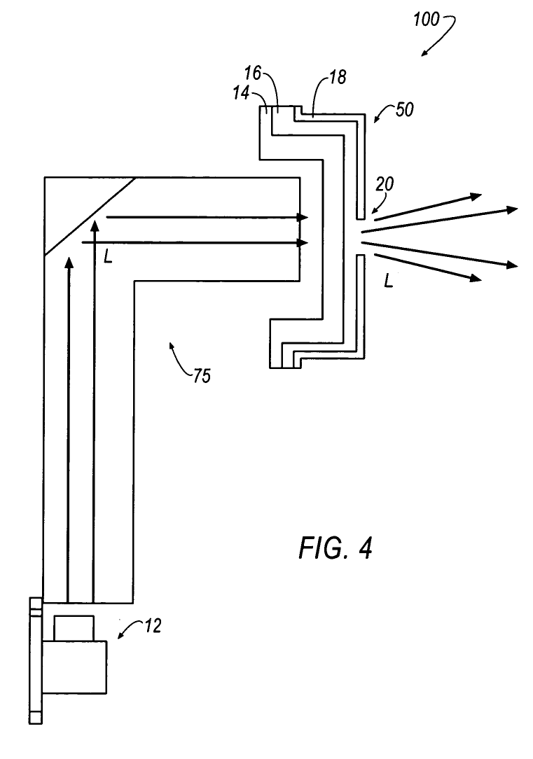

FIG. 4 illustrates another embodiment of a backlit display, which is generally shown at 100. In this embodiment, the light source 12 is not directly behind the cover 50. Instead, the light emitted from the light source 12 is directed through any known light-carrying conduit, such as a light pipe 75 before being output to the cover 50. Using a light pipe 75 eliminates the need to place the light source 12 directly behind the cover 50, providing designers with more flexibility in the relative positions between the light source 12 and the cover 50.

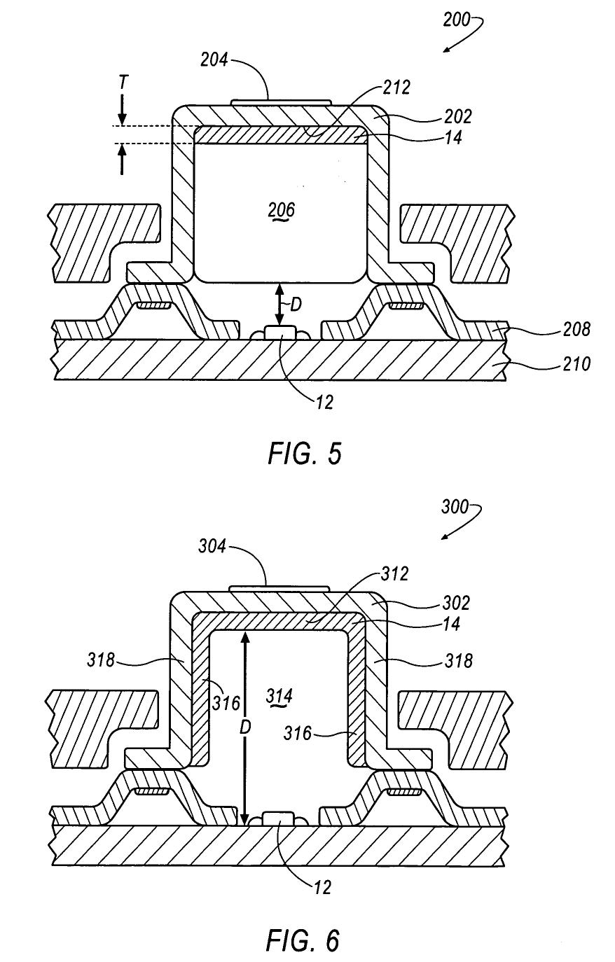

FIG. 5 illustrates yet another embodiment of a backlit display, which is generally shown at 200. The backlit display 200 generally comprises a button 202 having a graphics area 204 and lightpipe 206 mounted on a discrete silicon rubber switch dome 208 over a circuit board 210. The graphics area 204 may function and be formed in a similar manner as described above with respect to the topcoat 18 and openings 20; if desired, the graphics area 204 may include the opaque topcoat 18 with the openings 20. In this embodiment, the substrate 14 and lightpipe 206 are positioned at a distance, D, away from the light source 12 such that the substrate 14 is positioned adjacent to the button 202 proximate to the graphics area 204.

As illustrated, the substrate 14 is comprises a generally flat contour and maintains a constant thickness, T, about an upper surface 212 of the button 202. As explained above, if the thickness, T, is varied, color conversion of the light, L, is varied accordingly. Because the substrate 14 is positioned directly against upper surface 212 of the button 202, the conversion from the reference color light is ensured. Even further, the substrate 14 is positioned against the upper surface 212 of the button to decrease the distance of the converted light as it travels to upper surface 212, thus increasing the overall color-conversion efficiency of the source light by spacing the substrate 14 as far away from the light source 12.

FIG. 6 illustrates yet another embodiment of a backlit display, which is generally shown at 300. The backlit display 300 generally comprises the same elements and functions in a similar manner as described above in FIG. 5. In this embodiment, the substrate 14 comprises a generally hemispherical contour that is adjacently positioned to and encapsulates an inner cavity 314 of the button 302. Although the contour is illustrated to include a generally hemispherical shape, the contour may include any desirable form such as a box-shape or cylindrical-shape. As illustrated, an upper, generally flat surface 312 of the substrate 14 is positioned at a distance, D, away from the light source 12. According to the illustrated embodiment, light emitted from the light source 12 is enveloped by the hemispherical substrate 14 for color conversion. Thus, if the light is not directly passed through the graphics area 304, the light may travel toward a side wall portion 316 of the substrate 14, reflect off of a side wall 318 of the button 302, and travel through the graphics area 304 of the button 302.

To facilitate reflection of the converted light off of the side walls 318, the side walls 318 may include a generally opaque material. More specifically, the opaque material may be any desirable material such as plastic, TEFLON®, or SPECTRALON® comprising any reflective or light-colored material, that may be white, silver, or the like. If the plastic, TEFLON®, or SPECTRALON® material is not completely opaque, an opaque, white, silver or any other reflective color may be coated, painted, or applied via any desirable method over the side walls 318.

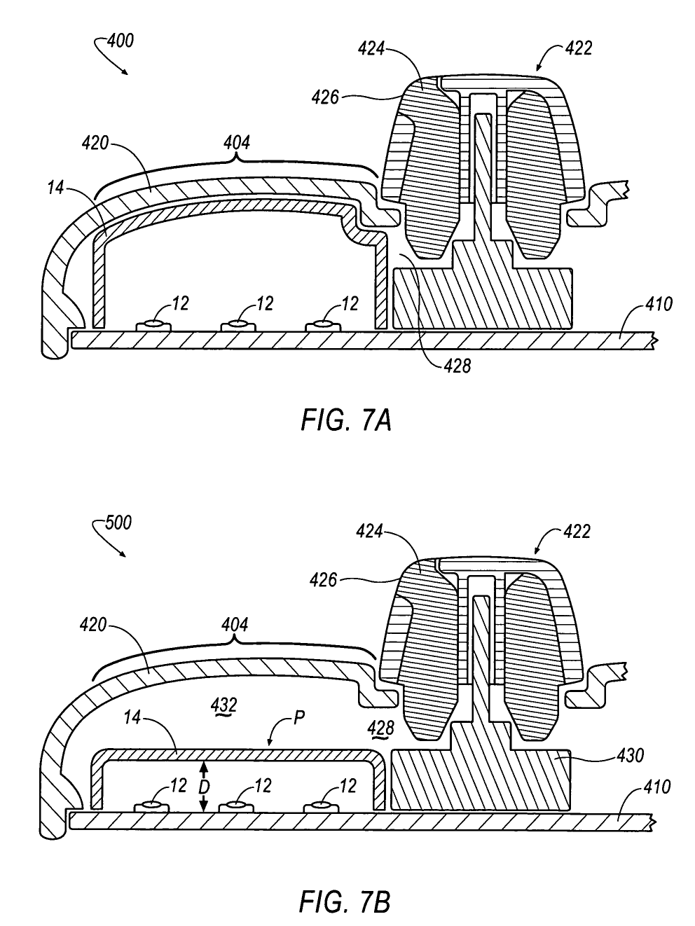

FIGS. 7A and 7B illustrates yet another embodiment of a backlit display, which is generally shown at 400 and 500, respectively. The backlit display 400 generally functions in a similar manner as described above in FIGS. 5 and 6. In this embodiment, the substrate 14 comprises a generally hemispherical contour that is adjacently positioned to a trim plate 420 including a graphics area 404 and a plunger-type button or knob 422 that includes an integral lightpipe 424 with a light-emitting area 426. As illustrated, the substrate 14 is sized such that multiple light sources 12 are located on a circuit board 410 under the trim plate 420. As illustrated, the trim plate 420 and knob 422 are positioned such that light may travel through the substrate 14 about a passage 428 to supply light to the lightpipe 424 for facilitating illumination of the emission area 426. If desired, the substrate 14 may be spaced from the circuit board 410 by a distance, D (FIG. 7B), such that the substrate 14 a common plane P extending from the body of a rotary electrical controller 430 coupled to the knob 422, thus integrating the passage 428 with a cavity area 432 behind the trim plate 420.

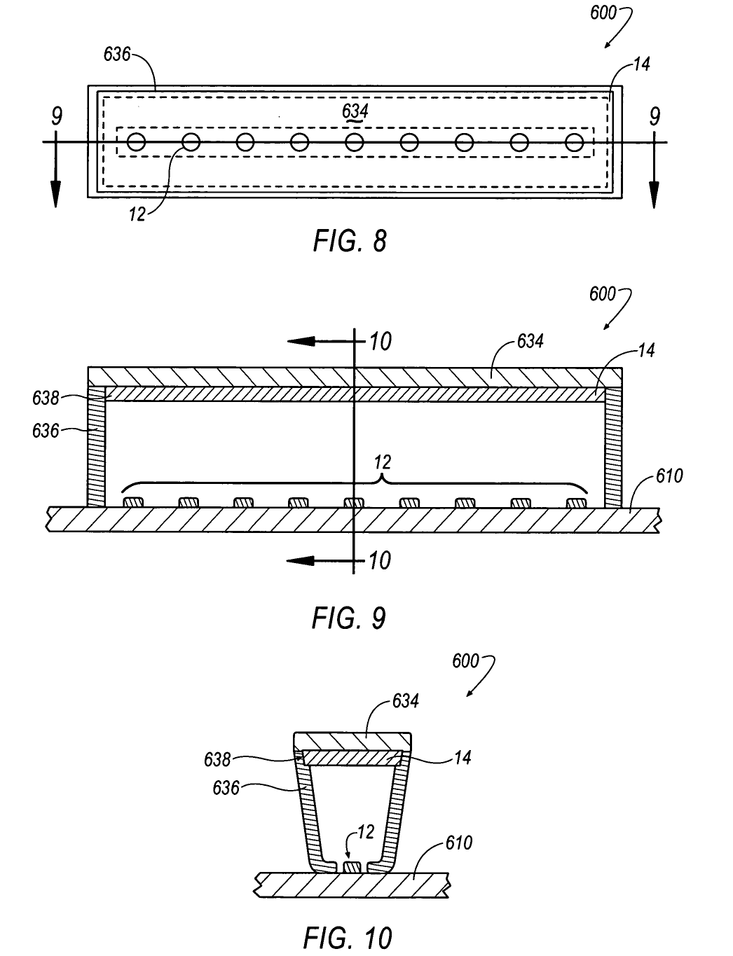

FIGS. 8-10 illustrates yet another embodiment of a backlit display, which is generally shown at 600. The backlit display 600 generally functions in a similar manner as described above in FIGS. 5-7B. In this embodiment, the substrate 14 is sized such that multiple light sources 12 are located on a circuit board 610 under a liquid crystal display (LCD 634) assembled to a reflective housing 636 having a beveled area 638 that receives the substrate 14. As explained above in FIG. 6, the reflective housing 636 facilitates reflection of emitted light from the light source 12 by comprising a generally opaque, diffusely reflecting material.

The substrate 14 may be affixed to the backlit displays 100, 200, 300, 400, 500, 600 by any desirable method. For example, as explained above in the embodiment relating to FIGS. 8-10, the substrate 14 may be received by a beveled area 638; alternatively, the substrate 14 may be affixed to structure of the backlit displays 100, 200, 300, 400, 500, 600 via an adhesive, pins that extend through holes in the circuit board or silicon rubber switch dome that may be ultrasonically welded, or integrally-formed datums in the substrate 14 that are snapped into holes formed in the circuit board or silicon rubber switch dome.

By incorporating a colored fluorescing material into the substrate 14 itself rather than applying colored materials and fluorescing materials as separate layers onto the substrate 14, the invention reduces the number of manufacturing steps needed to generate a desired backlighting. Further, the back light source 12 according to one embodiment invention, does not need to emit all the wavelengths necessary to obtain the desired backlighting color. Instead, the fluorescing dye(s) is/are selected so as to absorb at least a portion of the source 12 light, and then re-emit this light at longer wavelengths appropriate for the desired backlighting color.

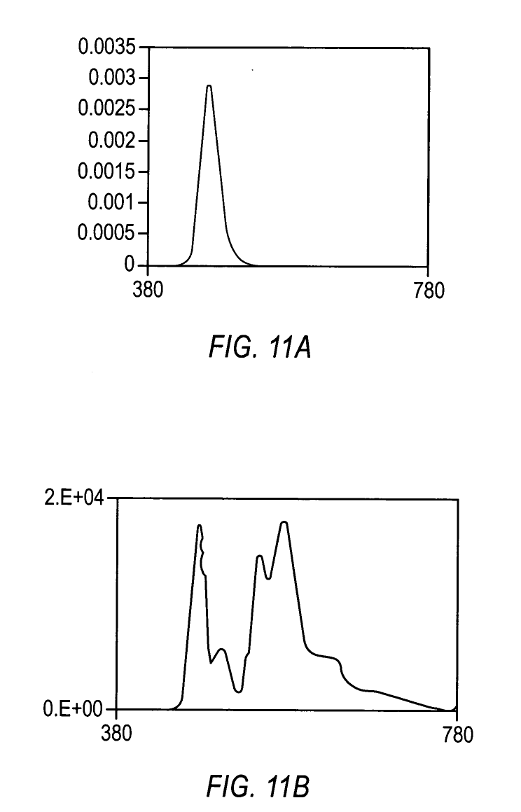

For example, as illustrated in FIG. 11A, the back light source 12 emits light of a first frequency spectrum. FIG. 11A represents the spectral energy of the light from the light source 12, which comprises wavelengths over a limited spectrum. When the light emitted from the light source 12 is transmitted through a substrate 14 incorporating one or more fluorescing dyes, at least a portion of the energy of the back light is absorbed by the dyes and re-emitted at longer wavelengths. The resultant light departing the substrate 14 combines the spectral characteristics of the light from the back light source 12 and of the light generated by the one or more fluorescing dyes incorporated into the substrate 14. FIG. 11B shows that the resultant light has a wider range of wavelengths after passing through the substrate 14. As a result, varying the diffusing and/or fluorescing materials incorporated into the substrate 14 allows customization of the color and brightness of the final light backlighting the graphic.

Utilizing the inventive backlighting displays 10, 100, 200, 300, 400, 500, 600, non-white light sources 12 can be used to easily illuminate graphics regardless of their color. In one embodiment, the light source 12 chosen may generate a light spectrum with an energy level higher than that inherent to the desired resulting color. Specifically, the light generated by the light source 12 will have shorter wavelengths than light subsequently emitted from the fluorescing dye. For instance, for backlighting displays 10, 100, 200, 300, 400, 500, 600, a blue light can be converted to any color from a longer wavelength blue to a very long wavelength red at the lower end of the visible spectrum. Colors can also be combined to achieve a near-white backlight.

In one embodiment, the backlit displays 10, 100, 200, 300, 400, 500, 600, would utilize a blue light source 12 such as readily available blue LEDs used in many industries. However, the claimed invention is not limited to LEDs, but could be used with a variety of different types of light sources 12. Additionally, although it is preferred to utilize a light source 12 that emits energy within the longer-wavelength, blue spectrum, other light sources 12 that generate either higher or lower frequency energy could be used depending on the application.

Compared to prior systems, several advantages are achieved with the backlighting systems 10, 100, 200, 300, 400, 500, 600, disclosed above. By allowing the use of colored lights or lights of a limited frequency spectrum, one is no longer required to utilize more expensive and complicated “white” light sources 12. This is particularly true in terms of LED light sources. “White” LEDs, which are essentially blue LED dies packaged with orange phosphor, are extremely expensive. Additionally, due to the complexity of their manufacturing process, they demonstrate significant variability in not only the intensity of light they emit, but also the color or frequency, thereby necessitating the expenditure of time and money to test and sort each light. Similarly, booted LEDs, which include a tinted, elastomeric filter cap or boot over the LED, possess the same disadvantages of significant expense and variability in their color output. Since emitted light color is obtained via light conversion, backlighting systems 10, 100, 200, 300, 400, 500, 600, disclosed above are more energy efficient when compared to equivalent backlighting obtained via conventional light filtering.

The present invention also offers advantages over previous fluorescing dye-based backlit displays, which utilize an ordinary substrate that has no inherent fluorescing or diffusing properties. Instead, a diffusing substance and fluorescing dyes are applied externally to the substrate as separate layers, much like the opaque topcoat, thereby requiring additional steps in the manufacturing process. The claimed invention, by incorporating the diffusing substance and fluorescing dye into the substrate, is able to eliminate several production steps thereby reducing production time and costs.

It should be understood that various alternatives to the embodiments of the invention described herein may be employed in practicing the invention. It is intended that the following claims define the scope of the invention and that the method and apparatus within the scope of these claims and their equivalents be covered thereby.

1. A backlit display, comprising:
at least one light source;
a backlit component;
a light-transmitting substrate having at least one fluorescing material incorporated into said substrate, wherein the light-transmitting substrate is intermediately located between the light source and the backlit component such that the backlit component passes light through at least one selected portion of said substrate.

2. A backlit display according to claim 1, further comprising a diffusing material incorporated into said substrate for diffusing light passing through said substrate.

3. A backlit display according to claim 2, wherein said diffusing substance at least one selected from the group consisting of a silica-based material, a PTFE material, an inorganic filler, and an acrylic-based material.

4. A backlit display according to claim 1, further comprising a light-passing coating layer disposed between said substrate and said opaque layer.

5. A backlit display according to claim 1, wherein the light-passing coating layer is colored to reflect a daytime graphics color.

6. A backlit display according to claim 1, wherein said substrate is formed from a polymer.

7. A backlit display according to claim 1, wherein said fluorescing material is chosen based on a light spectrum of a light source and a desired light spectrum for said graphic.

8. A backlit display according to claim 1, wherein said light source is an light emitting diode (LED).

9. A backlit display according to claim 8, wherein said light source is a blue LED.

10. A backlit display according to claim 1, wherein the backlit component is a button and the passing of light through at least one selected portion of said substrate is facilitated by a graphics area formed about a surface of the button.

11. A backlit display according to claim 10, wherein the backlit display further comprises a lightpipe intermediately positioned in the button that is located between the substrate and the light source.

12. A backlit display according to claim 11, wherein the button is positioned over a discrete silicon rubber switch dome and a circuit board.

13. A backlit display according to claim 10, wherein the button includes a cavity defined by side walls that reflects light toward the selected portion of the substrate.

14. A backlit display according to claim 13, wherein the side walls include a reflective, opaque material.

15. A backlit display according to claim 1, wherein the backlit component is a trim plate positioned over a circuit board and the passing of light through at least one selected portion of said substrate is facilitated by a graphics area formed about a surface of the trim plate.

16. A backlit display according to claim 15, wherein the passing of light through at least one selected portion of said substrate is further facilitated by a rotary knob positioned about the trim plate, wherein the knob includes an integral lightpipe having a visible light-transmitting surface.

17. A backlit display according to claim 15, wherein the substrate is spaced from the circuit board by a distance such that the substrate is positioned about a common plane extending from a base potion of the knob.

18. A backlit display according to claim 1, wherein the backlit component is a liquid crystal display and the passing of light through at least one selected portion of said substrate is facilitated by a graphics area formed about a surface of the liquid crystal display.

19. A backlit display according to claim 18, wherein the backlit component further comprises a reflective housing including a beveled area that receives the substrate.

20. A backlit display according to claim 19, wherein the housing includes a reflective, opaque material.

21. A backlit display according to claim 1, wherein the substrate includes a contour.

22. A backlit display according to claim 21, wherein the substrate includes a contour having a constant thickness.

23. A backlit display according to claim 21, wherein the substrate includes a contour having a varying thickness.

24. A backlit display according to claim 21, wherein the contour is flat.

25. A backlit display according to claim 21, wherein the contour is hemispherical.

26. A backlit display according to claim 21, wherein the contour is box-shaped.

27. A backlit display according to claim 21, wherein the contour is cylindrical.
